(19) United States
(12) Patent Application Publication
(10) Pub. No.: US 2026/0045689 A1
(43) Pub. Date: Feb. 12, 2026

(54) WIDEBAND HYBRID COUPLER FOR CONSTANT BANDWIDTH TUNING WITH IN-BAND AND OUT-OF-BAND RADIO FREQUENCY MATCHING

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/798,256

(22) Filed: Aug. 8, 2024

(51) Int. Cl. H01Q 3/38

(52) U.S. Cl. CPC H01Q 3/38

(57) ABSTRACT

The technology described herein is directed towards a wide-bandwidth, high-frequency (e.g., millimeter wave) hybrid coupler. One implementation of the hybrid coupler is passive and compact, is designed with a single top metallization layer, and does not require any interconnecting layer. The planar design can include four ports coupled to the four sides of a rectangular (e.g., square) metal plane portion, with cross-shaped slots that intersect in the center of the metal plane portion, and two back-to-back connected slanted bracket slots for efficiently routing E- and H-fields to other ports. Design tweaks can change the radio frequency (RF) characteristics of the hybrid coupler, including, for example, scaling the hybrid coupler dimensions to establish the center frequency, while retaining constant bandwidth. Other tweaks can be made to the dimensions of the cross-shaped slots. The design facilitates integration with other planar RF technologies.

### BACKGROUND

The telecommunications industry is moving towards communications based on higher frequencies to accommodate the soaring demand for bandwidth. For example, beamforming networks have the need for various radio frequency (RF) components, including hybrid couplers. A hybrid coupler, sometimes referred to as a quadrature coupler or a ninety-degree (90°) coupler, is a passive four-port device that offers signal splitting and combining, with 90° phase difference between two ports. Hybrid couplers, used in phase-sensitive applications like Butler matrices and antenna feed networks, encounter significant challenges at millimeter-wave (mmWave) frequencies.

At mmWave frequencies, the bandwidth limitation of traditional hybrid couplers remains a significant issue. As the frequency increases, the wavelength decreases, leading to pronounced effects of parasitics, material imperfections, and fabrication tolerances, which in turn narrow the operational bandwidth and affect overall system performance.

### BRIEF DESCRIPTION OF THE DRAWINGS

The technology described herein is illustrated by way of example and not limited in the accompanying figures in which like reference numerals indicate similar elements and in which:

FIG. 1 is top view representation of an example layout of a planar hybrid coupler, showing various parts thereof, in accordance with various embodiments and implementations of the subject disclosure.

FIG. 2 is a three-dimensional (3D) perspective top view of a model of an example hybrid coupler corresponding to FIG. 1, in accordance with various embodiments and implementations of the subject disclosure.

FIG. 3 is a 3D perspective bottom view of a model of the example hybrid coupler corresponding to FIGS. 1 and 2, in accordance with various embodiments and implementations of the subject disclosure.

FIG. 4 is top view representation of an example layout of a planar hybrid coupler, showing various design dimensions, in accordance with various embodiments and implementations of the subject disclosure.

FIG. 5 is a block diagram showing an example system for determining design parameters for a millimeter-wave hybrid coupler, in accordance with various embodiments and implementations of the subject disclosure.

FIG. 6 is a graphical representation of a simulation response of the example hybrid coupler designed with a constant 4 GHz bandwidth and a 28 GHz center frequency, showing scattering parameters (S-parameters) for frequency versus magnitude, in accordance with various example embodiments and implementations of the subject disclosure.

FIG. 7 is a graphical representation of a simulation response of the example hybrid coupler designed with a constant 4 GHz bandwidth and a 28 GHz center frequency, showing S-parameters for frequency versus phase response, in accordance with various example embodiments and implementations of the subject disclosure.

FIG. 8 is a graphical representation of a simulation response of the example hybrid coupler designed with a constant 4 GHz bandwidth and a 27 GHz center frequency, showing S-parameters for frequency versus magnitude, in accordance with various example embodiments and implementations of the subject disclosure.

FIG. 9 is a graphical representation of a simulation response of the example hybrid coupler designed with a constant 4 GHz bandwidth and a 27 GHz center frequency, showing S-parameters for frequency versus phase response, in accordance with various example embodiments and implementations of the subject disclosure.

FIG. 10 is a graphical representation of a simulation response of the example hybrid coupler designed with a constant 4 GHz bandwidth and a 29 GHz center frequency, showing S-parameters for frequency versus magnitude, in accordance with various example embodiments and implementations of the subject disclosure.

FIG. 11 is a graphical representation of a simulation response of the example hybrid coupler designed with a constant 4 GHz bandwidth and a 29 GHz center frequency, showing S-parameters for frequency versus phase response, in accordance with various example embodiments and implementations of the subject disclosure.

FIG. 12 is a representation of a schematic of a Butler matrix beamforming network that includes example hybrid couplers as described herein, in accordance with various example embodiments and implementations of the subject disclosure.

FIGS. 13-15 comprise a flow diagram showing example operations related to determining design parameters for a hybrid coupler based on input parameters, and configuring the hybrid coupler to be implemented based on the design parameters, in accordance with various example embodiments and implementations of the subject disclosure.

### DETAILED DESCRIPTION

The technology described herein is generally directed towards a wideband hybrid coupler designed as a planar component with design variables that facilitate tuning of in-band and out-of-band RF matching, in addition to preserving constant bandwidth with a change in the center frequency. In one example implementation, the hybrid coupler described herein includes a top metallization layer with four ports, a metal plane, cross-shaped slots in the top metallization layer and in a ground plane layer, and two back-to-back connected slanted (angled) bracket slots in the middle of the coupler. In general, the hybrid coupler efficiently channels E- and H-fields to the ports, overcoming common issues experienced by other hybrid coupler designs, including high loss and inadequate field distribution. Significantly, the hybrid coupler described herein features a broadband capability with a constant bandwidth, significantly simplifying frequency scaling for designers. This allows for the hybrid coupler as described herein to be easily adjusted to desired frequencies without the cumbersome, computationally heavy optimization required by other components, which can take several hours to days. In addition, the technology described herein does not involve any stringent dimensional variabilities, thus reducing the cost of manufacturing significantly.

Further, the passive hybrid coupler design utilizes a dual-layer metal approach that removes the need for any interconnecting layers. This distinguishes the technology described herein from commercially available couplers and designs proposed by other researchers. The example design described herein is scalable, and demonstrates low insertion loss at millimeter wave (mmWave) frequencies, achieved through the use of the angled bracket slots in the coupler's center. By solving the many problems associated with commercially available couplers and those designed by other researchers, such as scalability issues, high insertion losses, and complex optimization processes, the technology described herein offers a streamlined, efficient alternative, and ultra-low-cost solution for mmWave circuits and systems.

There is thus described a passive hybrid coupler implemented using a using planar circuit approach without requiring any interconnecting layer and having constant bandwidth scalability with selection of the slot design dimensions. The fully parametrized design results in a broadband coupler with constant bandwidth, which helps designers scale the coupler to a desired center frequency, providing an ultra-low-cost solution for mm Wave circuits and systems.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” “between” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

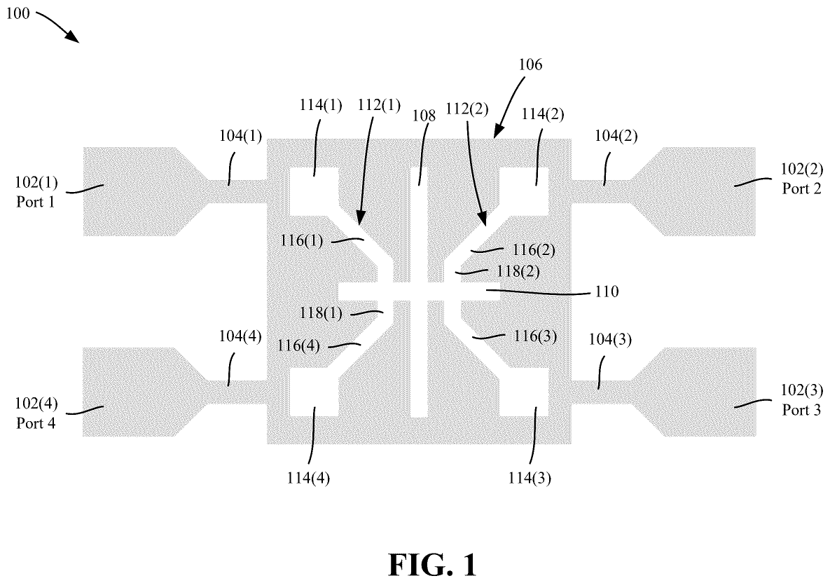

FIG. 1 shows a top view of an example wideband hybrid coupler 100 including a metallization layer (the lightly shaded portion) with four ports 102(1)-102(4) coupled by microstrip lines 104(1)-104(4), respectively, to a rectangular-shaped (e.g., square geometry) metal plane portion 106. As in general with hybrid couplers, the four ports 102(1)-102(4) (also labeled Port 1-Port 4), define Port 1 as the input port, Port 2 as the through port, Port 3 as the coupled port, and Port 4 as the isolated port.

The metal plane portion 106 includes various slot openings, or simply slots, as described herein. More particularly, the metal plane portion 106 includes two centralized cross-shaped (e.g., substantially perpendicular to each other) slots 108 and 110 that intersect at a centralized intersection point, and two back-to-back connected coupled slanted (angle) bracket slots 112(1) and 112(2) overlapping the cross-shaped slots 108 and 110.

The coupled slanted bracket slot 112(1) includes a first coupler end slot 114(1) proximate to the first microstrip line 104(1), and a fourth coupler end slot 114(4) proximate to the fourth microstrip line 104(4). The coupled slanted bracket slot 112(1) also includes a first angled slot 116(1) (part of the angled bracket shape) that angles inwardly from the first coupler end slot 114(1) at a first coupler angle towards the centralized intersection point, and a fourth angled slot 116(4) that angles inwardly from the fourth coupler end slot 114(4) at a fourth coupler angle towards the centralized intersection point. A first connecting slot 118(1) couples the first angled slot 116(1) to the fourth angled slot 116(4), and intersects the second centralized slot 110.

On the opposite side, the metal plane portion 106 includes the coupled slanted bracket slot 112(2), which includes a second coupler end slot 114(2) proximate to the second microstrip line 104(2), and a third coupler end slot 114(3) proximate to the third microstrip line 104(3). The coupled slanted bracket slot 112(2) also includes a second angled slot 116(2) (part of the angled bracket shape) that angles inwardly from the second coupler end slot 114(2) at a second coupler angle towards the centralized intersection point, and a third angled slot 116(3) that angles inwardly from the third coupler end slot 114(3) at a third coupler angle towards the centralized intersection point. A second connecting slot 118(2) couples the second angled slot 116(2) to the third angled slot 116(3), and also intersects the second centralized slot 110.

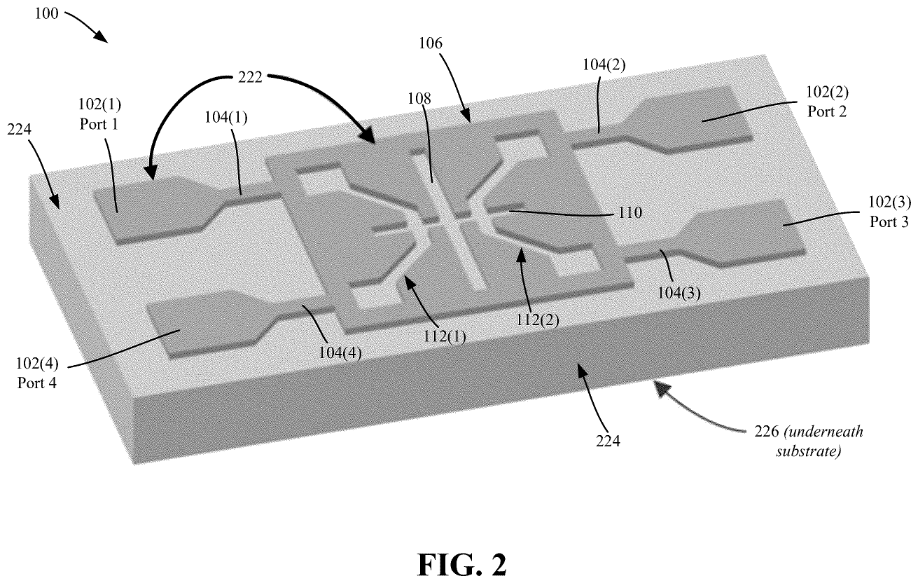

FIG. 2 is a three-dimensional (3D) perspective top view representation of the example hybrid coupler 100, in which the top metallization layer 222 is on a substrate 224. Some of the component metal parts and slots are labeled as in FIG. 1, and are not described again. Beneath the substrate is a bottom metallization layer 226 (obscured by the substrate 224 in FIG. 2) that serves as a ground plane.

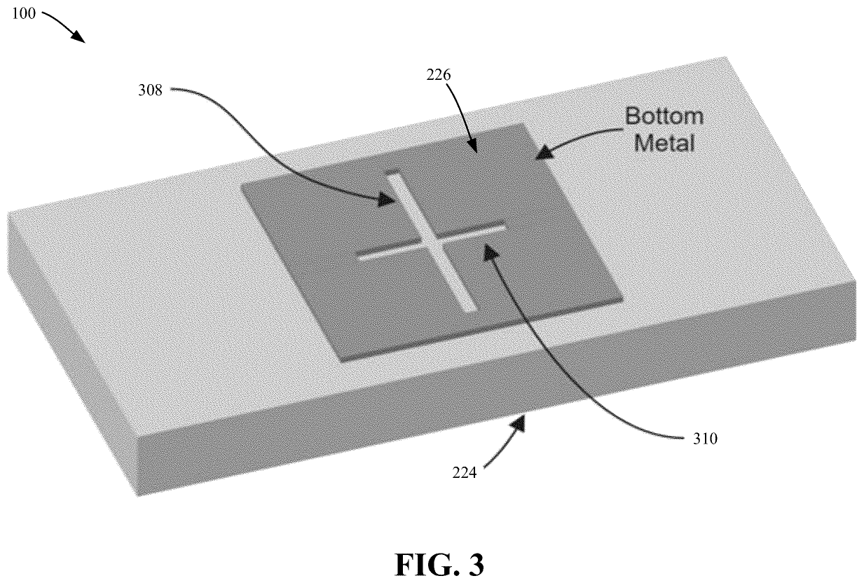

FIG. 3 is a three-dimensional (3D) perspective bottom view representation of the example hybrid coupler 100, in which at least a portion of the ground plane (bottom metallization layer) 226 is beneath the dielectric substrate 224 in this upside-down view. The bottom metal layer includes two cross-shaped slots 308 and 310, which in one implementation align with the two cross-shaped slots 108 and 110 in the upper plane portion 106 (FIG. 2). The lengths and/or widths of the bottom cross slots 308 and 310 can be tweaked to account for dielectric constant changes such as a change in the substrate from one dielectric material to another dielectric material.

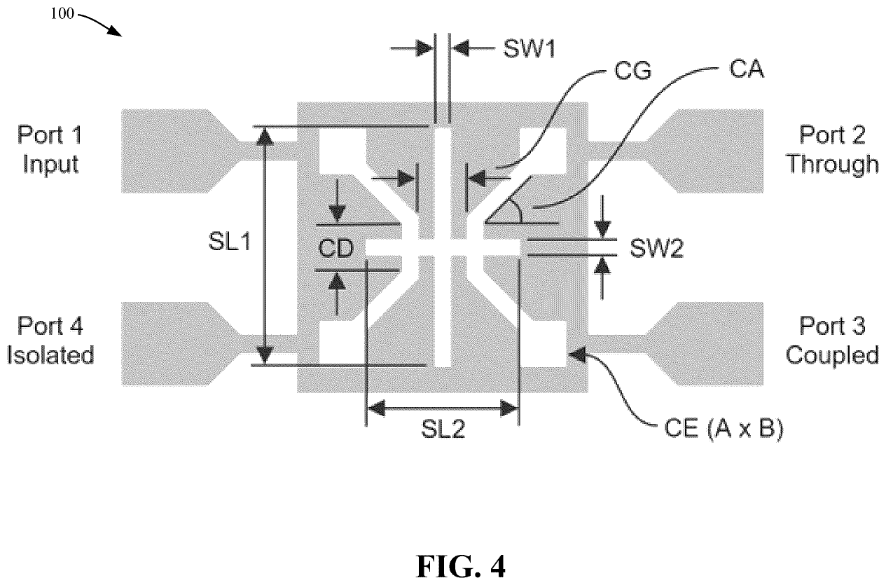

FIG. 4 shows design variables of the example square-shaped geometry hybrid coupler 100; (unlike FIG. 1, numerical labels are intentionally omitted in FIG. 1 so as to not obscure the identified design dimensions). The example hybrid coupler 100 is designed using the two cross-shaped slots in the center with the first slot having width SW1 and length SL1, and the second slot having width SW2 and length SL1 The two back-to-back connected coupled slots overlap the cross-shaped slots as shown in FIG. 4.

The hybrid coupler has the four ports, namely, port 1 as an input port, port 2 for through signal, port 3 for coupled signal output with 90° phase difference, and an isolated port 4. Port lengths and widths are chosen to have a characteristic impedance of 50Ω, but can be varied to accommodate any other impedance (e.g., in case the coupler is required right after an antenna). Actual dimensions are not provided as this design is scalable, whereby a designer only needs to scale the size of the overall structure to change the frequency band.

The following table shows additional details of the design dimensions identified in FIG. 4 and their effect on performance:

| Variable | Description | Purpose |
|---|---|---|
| SW1 | Slot Width 1 | Coupling strength of E- and H-Fields |
| SW2 | Slot Width 2 | Coupling strength of E- and H-Fields |
| SL1 | Slot Length 1 | Coupling strength of E- and H-Fields |
| SL2 | Slot Length 2 | Coupling strength of E- and H-Fields |
| CG | Coupler Gap | To change the bandwidth |
| CA | Coupler Angle | To tune the in-band matching |
| CE | Coupler End Slots | Square slot of size A × B to match phase |
| CD | Coupler Distance | To tweak the bandwidth |

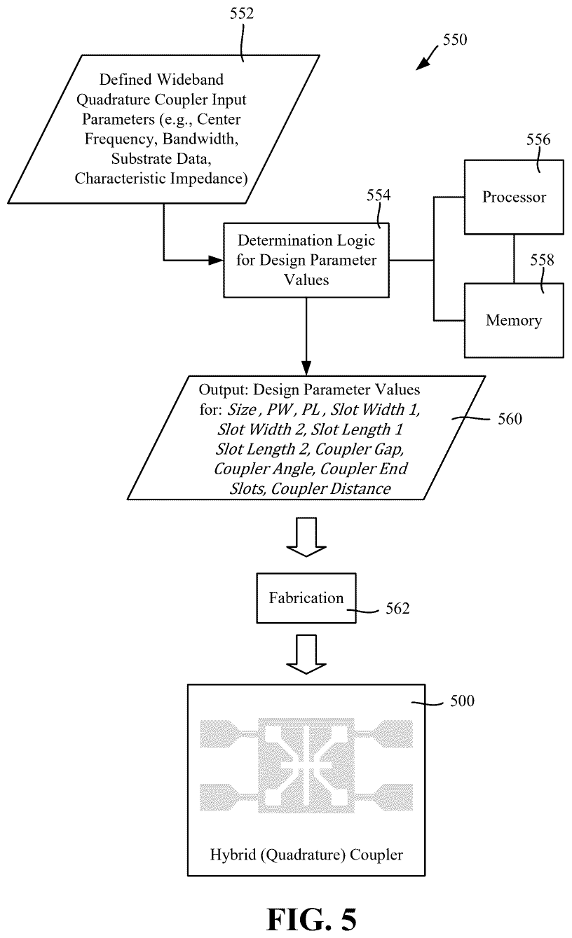

FIG. 5 shows a generalized block diagram of an example system 550 for designing a compact, single layer wideband passive hybrid coupler 500 based on defined needs of an application, represented by input parameters 552, including, but not limited to the desired, center frequency, bandwidth substrate data (e.g., material), and characteristic impedance Z₀. Determination logic 554, e.g., executed via at least one processor 556 and memory 558, can determine the output design parameter values 550 for the dimensions and other factors for a wideband hybrid coupler 500 that achieves these input parameters 552. These include the variables in the above table, that also determine other RF characteristics of the hybrid coupler 500, including optimizing/fine-tuning the S-parameters for certain substrate materials, and increase or decrease the bandwidth limits, at least to an extent. The ports' length and width (PL and PW) values (to meet the desired characteristic impedance Z₀) can be determined as part of the output design parameter values 560. Once the parameters are optimized and the hybrid coupler is tuned as desired, a user only need to scale the overall hybrid coupler.

Based on these output design parameter values 560, fabrication (represented by block 562) can be performed in a straightforward manner by any suitable technique that fabricates the single top metallization layer on the substrate, and fabricates the bottom metallization layer beneath the substrate. The result is a compact, relatively low-cost hybrid coupler 500 as described herein that provides significant benefits in high-frequency (e.g., mmWave) applications.

The compact hybrid coupler described herein is highly appropriate for mm Wave systems and technologies such as 5G and beyond; the compact design reduces material and manufacturing costs, while enabling the creation of more sophisticated, higher-density array architectures that are needed for the high-speed, high-capacity demands of future wireless communication systems. Note that the single top metallization layer hybrid circuit design described herein is in contrast to a typical hybrid circuit, which typically have a very narrow bandwidth in the range of only a few megahertz, which limits their use for broadband applications, such as 5G-advanced or 6G applications where significantly larger bandwidth is needed. Indeed, as the telecommunications industry advances towards higher frequencies to meet the increasing demand for bandwidth, the design and implementation of RF components pose new challenges. Among these, hybrid couplers, needed for phase-sensitive applications such as RF mixers, modulators, and antenna feed networks, face significant limitations. Traditional hybrid couplers, while effective at lower frequencies, are unable to adequately maintain performance across the wide bandwidths needed by millimeter-wave applications.

The development of hybrid couplers suitable for mmWave applications poses its own set of challenges, including the need for integration with planar technologies, miniaturization, and maintaining high performance over a wide frequency range. As the frequency increases, the wavelength decreases, leading to pronounced effects of parasitics, material imperfections, and fabrication tolerances, which in turn narrow the operational bandwidth and affect the overall system performance. Among the narrow operational bandwidth limitation, other limitations include high insertion loss at poor isolation, and degraded phase and amplitude balance, which severely impact the efficiency and reliability of high-frequency wireless systems. At high frequencies, the inherent physical and electrical constraints of hybrid couplers limit their application. These limitations hold back the potential of mm Wave technologies, and also limit the scalability and versatility of communication systems.

The fundamental topology for the implementation of a conventional hybrid coupler with characteristic impedance Z0 can have a conventional microstrip configuration; however, both the series and shunt branches of the conventional device are required to have a length of λ/4. While this implementation approach is straightforward, it presents a significant limitation regarding bandwidth. The reason for this limitation is that the line lengths achieve λ/4 only at a specific frequency. Such hybrid couplers are thus favored in low-frequency applications, including cellular phones, where a narrow bandwidth of a few MHz suffices. However, for mmWave systems, this basic design approach is inadequate due to the inherent losses at high frequencies and the requirement for a broader bandwidth.

Commercially-available hybrid couplers offer several advantages and disadvantages that impact their application in RF systems. On the positive side, commercially-available hybrid couplers are readily available, whereby designers can easily incorporate them into various systems without the need for custom development, thereby reducing lead times. Additionally, they tend to exhibit low loss, enhancing system efficiency and performance, and are generally reliable, ensuring stable operation over their intended lifespan. However, these benefits are counterbalanced by several drawbacks, including that hybrid couplers are often expensive, which can significantly increase the cost of systems in which they are used. For example, in the context of an 8×8 beamforming network using a Butler matrix, the requirement for multiple hybrid couplers, each potentially costing approximately US $1,500, can make the system prohibitively expensive and impractically bulky; an 8×8 beamforming network using a Butler matrix requires twelve hybrid couplers, which drives the cost of the device by an additional US $18,000.

Furthermore, traditional hybrid couples may suffer from low isolation, and sometimes exhibit high phase imbalance over the frequency range, which can degrade the performance of RF systems. Their relatively large size and bulkiness also present challenges in terms of integration, and can limit their use in compact or portable applications.

Researchers have proposed various solutions to address the challenges associated with the design of hybrid couplers. For instance, a multi-layer implementation has been attempted, but necessitates a complex fabrication process that includes glass processing and etching, as well as the use of non-standard materials. This approach not only potentially increases manufacturing costs but may also result in lower yields. Additionally, this approach is plagued by suboptimal RF performance at mmWave frequencies, characterized by significant issues such as high insertion loss, inadequate return loss, and a limited bandwidth of merely 500 megahertz. One other ultra-wideband hybrid coupler featured negligible loss and provided exceptional performance and a compact design footprint, however, it was fabricated using a superconducting microfabrication process, which is not commercially available, and moreover, the device operates effectively only at cryogenic temperatures suitable for quantum hardware, but demonstrated inferior RF performance at room temperature.

To simulate in a 3D field solver, ports were defined as lumped ports. One implementation chose lumped ports with 50Ω characteristic impedance and 30 dBm (1 Watt) of input RF power. A scalable radiation box was designed to accommodate the study of E- and H-field. For this design, a standard Rogers® 4000 series substrate was chosen, but for different substrate materials such as FR4 laminates, alumina, silicon, glass, or any other dielectric material, the hybrid coupler can be optimized by only varying the slot width and length of both slots, which can be in addition to varying port width and port length, and which can be parametrized to achieve desired performance for a specific dielectric constant and loss tangent.

To simulate in a 3D field solver, ports need to be defined as lumped ports. We chose lumped ports with 50Ω characteristic impedance and 30 dBm (1 W) of input RF power. A scalable radiation box is designed to accommodate the study of E- and H-field. For this presented design, a standard Rogers® 4000 series substrate is chosen, but for different substrate materials such as FR4 laminates, alumina, silicon, glass, or any other dielectric material, the hybrid coupler can be optimized for the proper routing of the E- and H-fields by only varying the slot widths and lengths of both slots in addition to varying port width and length, that can be parametrized to achieve desired performance for a specific dielectric constant and loss tangent. The bottom side slots allow for any change in the dielectric constant; for example, if the design is optimized for FR4 substrate, the coupler can provide similar performance if there is a change in the substrate by tweaking the length and width of the both cross-shaped slots in the bottom side of the device. Various other performance parameters such as coupling strength, phase optimization, in-band and out-of-band RF matching can be tweaked by changing the gap, distance, angle, and/or area of back-to-back connected slots as set forth in the above table.

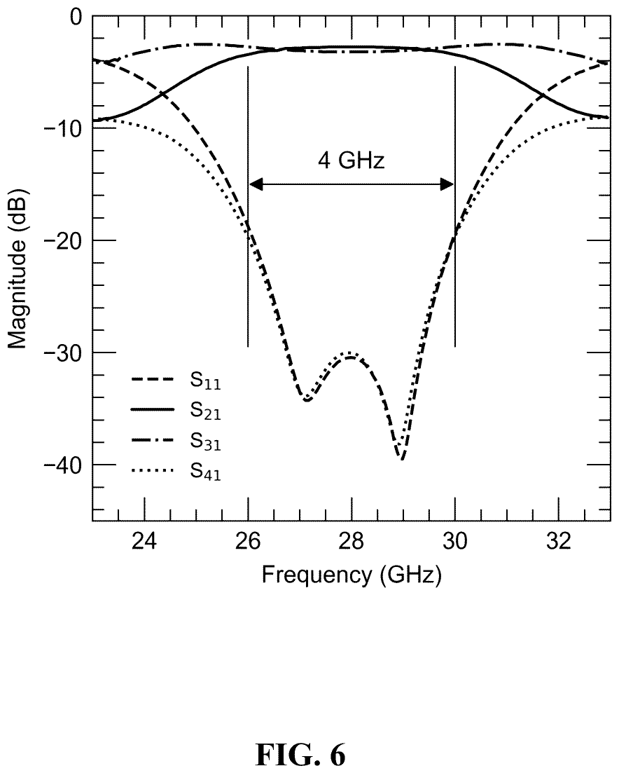

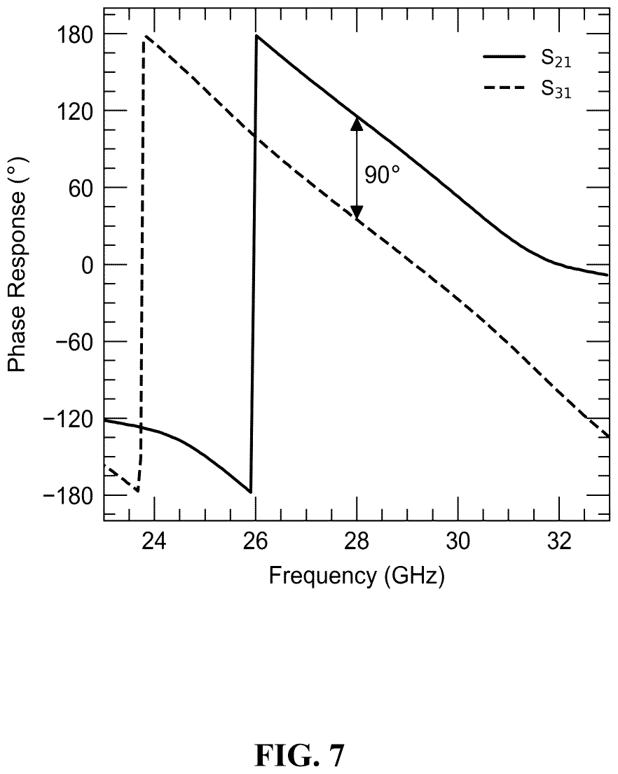

The EM simulation response (magnitude and phase response) of the hybrid coupler is shown in FIGS. 6 and 7 demonstrating excellent RF performance over 4 GHz bandwidth with 28 GHz center frequency. The S-parameter magnitudes for varying frequencies are shown in FIG. 6. The phase response (FIG. 7) shows phase profile lines over the band with constant 90° phase different between port 2 and 3. The bandwidth of the hybrid coupler is dictated when the S₂₁ and S₃₁ is 3 dB (a 50:50 split).

A low insertion loss can be seen in FIG. 6 from S₂₁, the signal flowing from port 1 to 2, and S₃₁, the signal flowing from port 1 to 3. The S₁₁ is below 20 dB over the band, iterating a near ideally matched circuit with no reflections, and S₄₁ better than −20 dB, demonstrating better isolation. In fact, in the design described herein, the isolation is better than 22 dB over the band, in contrast to commercially available couplers that have isolation of 17 dB. The through (port 2) and coupled (port 3) show strong 3 dB coupling, which is a highly desirable trait of a hybrid coupler; to reiterate, a 3 dB difference means equal split of the signal (50:50) between two ports, and an insertion loss is any loss above 3 dB value. In the design described herein, the loss of the coupler is lower than 0.5 dB over the entire band.

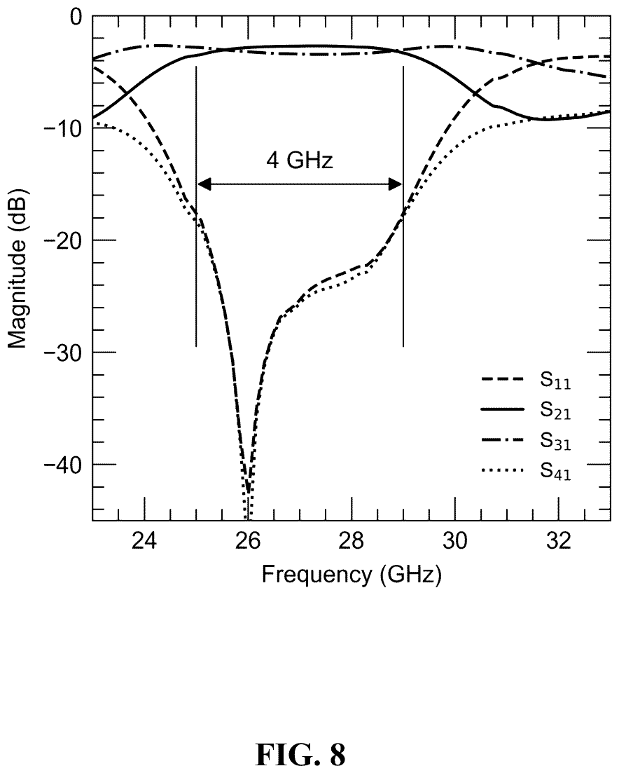

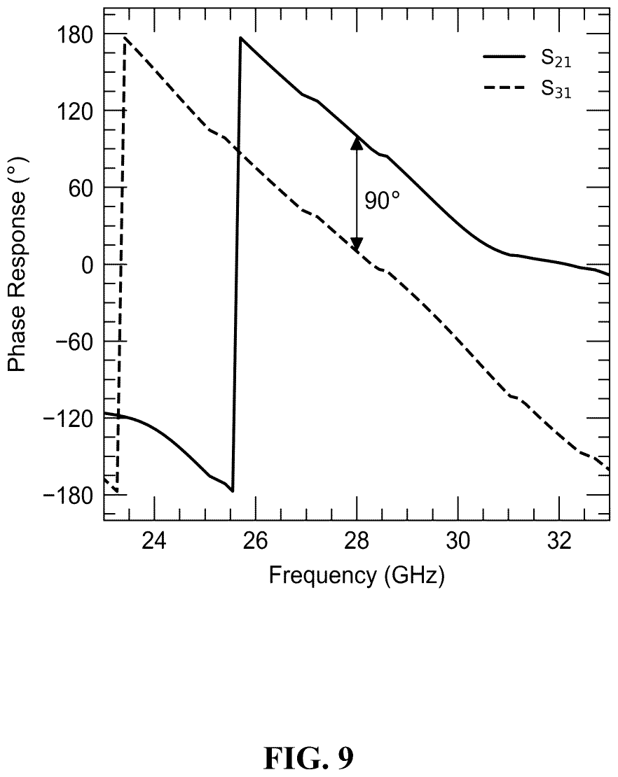

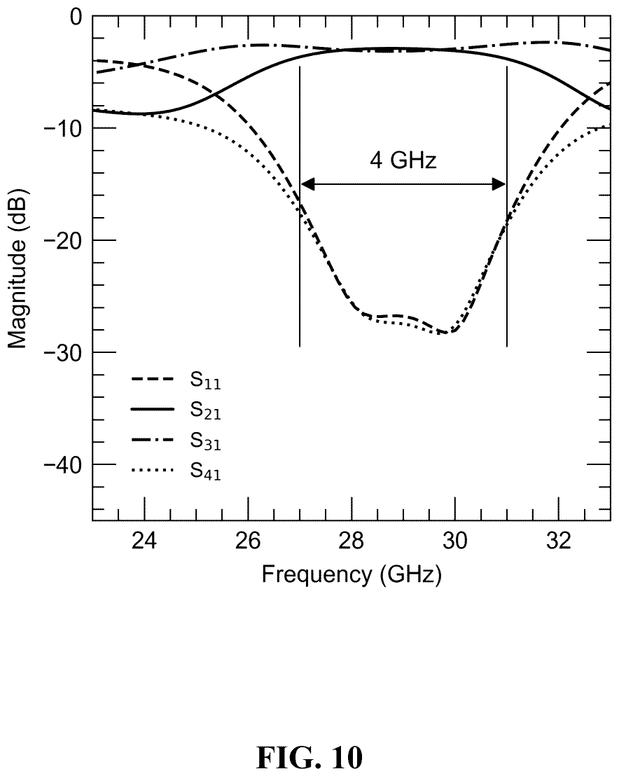

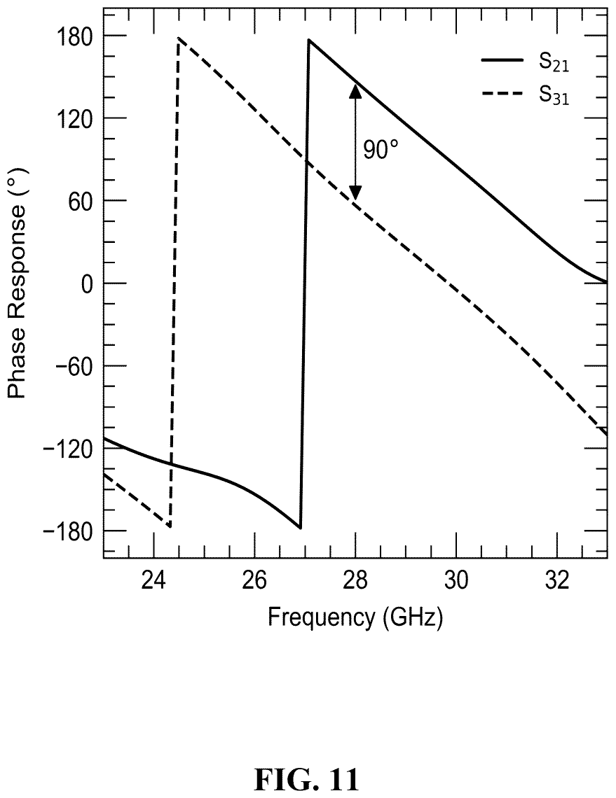

When the coupler is scaled a bit larger than the designed X-Y dimensions corresponding to FIGS. 6 and 7, the center frequency can be tuned while keeping the bandwidth consistent, as shown in FIGS. 8 and 9. Conversely, when the X-Y dimensions are shrunken, the center frequency is increased from 28 to 29 GHz, while still keeping the constant 4 GHz bandwidth and balanced 90° phase difference as shown in FIGS. 10 and 11

Turning to some use case examples for hybrid couplers, hybrid couplers are often used in balanced mixers and modulators to ensure that signals are combined or split with a 90-degree phase difference. Hybrid couplers based on the example design described herein can achieve high performance in terms of linearity and suppression of unwanted signals.

Hybrid couplers are used in antenna feeding networks. More particularly, in complex antenna systems, such as phased arrays, hybrid couplers based on the example design described herein can be used to feed antennas in a manner that allows for beam steering and shaping by controlling the phase and amplitude of the signal going to each antenna element.

With respect to signal distribution and combining, hybrid couplers based on the example design described herein can be used to evenly split an input signal into two output signals with a 90-degree phase difference between them, or combine two signals while maintaining this phase difference. This is useful in applications requiring precise phase control and signal routing, such as in certain radar and communication systems.

For phase shifters, adjusting the impedance seen at the ports of a hybrid coupler based on the example design described herein can create a phase shift in the signal, which is useful for phased array antennas and other applications requiring precise control over the signal phase. With respect to directional couplers, hybrid couplers as described herein can be used as a specific type of directional coupler used for measuring the power flowing in a transmission line, sampling signals without disturbing the main flow, and for SWR (Standing Wave Ratio) measurements.

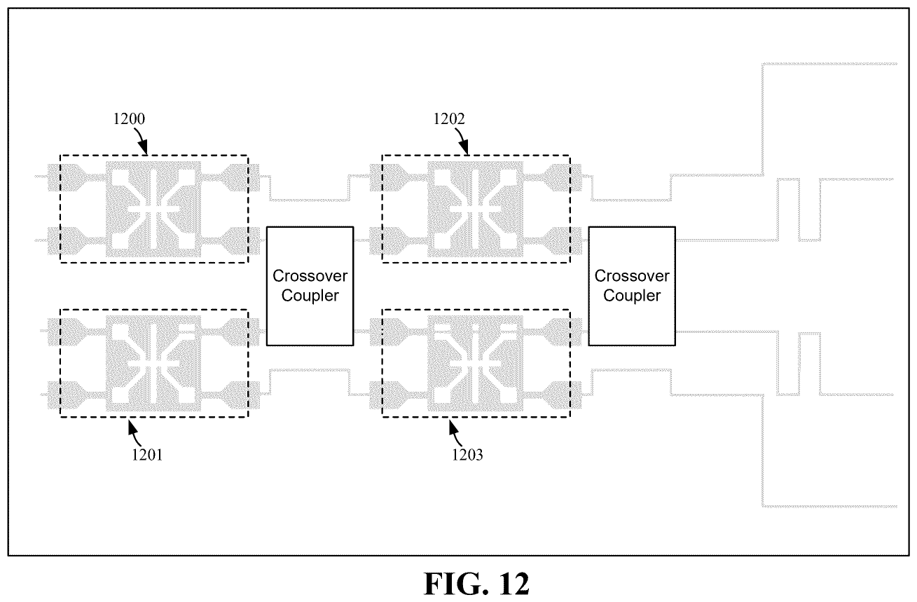

With respect to mmWave hybrid (hybrid) coupler uses, in mmWave communication systems, including 5G and beyond, hybrid couplers based on the example design described herein can be used in the deployment of 5G cellular networks, especially for beamforming in base stations and small cells. These couplers enable the precise control of signal phase and amplitude needed for directing beams towards users and away from interference. FIG. 12 shows hybrid couplers 1200-1203 as described herein incorporated into a Butler matrix beamforming network.

In advanced driver-assistance systems (ADAS) and autonomous vehicles, mmWave hybrid (hybrid) couplers as described herein can be used in automotive radar systems operating in the 24 GHz, 77 GHz, and 79 GHz bands for object detection, speed measurement, and collision avoidance.

For satellite communication systems, especially those operating in the Ka-band and above, mmWave hybrid couplers as described herein can be used for signal routing, phase adjustment, and polarization control to maximize the efficiency and reliability of high-frequency satellite links. In point-to-point microwave links used for wireless backhaul, mmWave hybrid couplers such as based on the example design described herein enable the efficient distribution and combination of signals over the millimeter-wave spectrum, facilitating high-capacity data transmission over long distances. For both terrestrial and space applications, mmWave hybrid couplers as described and represented herein can be integral to phased array antenna systems, allowing for dynamic beam shaping and steering by controlling the phase and amplitude of signals fed into the antenna elements.

One or more example embodiments can be embodied in a hybrid coupler, such as described and represented herein. The hybrid coupler can include a top metallization layer, which can include a metallic upper plane, and a first port coupled to the metallic upper plane via a first microstrip line, a second port coupled to the metallic upper plane via a second microstrip line, a third port coupled to the metallic upper plane via a third microstrip line, and a fourth port coupled to the metallic upper plane via a fourth microstrip line, wherein the first port can be opposite the third port, the first port can be adjacent to the second port, and the first port can be the adjacent to the fourth port. The top metallization layer further can include a first centralized slot in the metallic upper plane, a second centralized slot in the metallic upper plane, wherein the first centralized slot crosses the second centralized slot at a centralized intersection point, a first bracket-shaped slot in the metallic upper plane. The first bracket-shaped slot can include a first coupler end slot proximate to the first microstrip line, a first angled slot that angles inwardly from the first coupler end slot at a first coupler angle towards the centralized intersection point, a fourth coupler end slot proximate to the fourth microstrip line, a fourth angled slot that angles inwardly from the fourth coupler end slot at a fourth coupler angle towards the centralized intersection point, and a first connecting slot that couples the first angled slot to the fourth angled slot, and that intersects the second centralized slot.

The top metallization layer further can include a second bracket-shaped slot in the metallic upper plane, and the second bracket-shaped slot can include a second coupler end slot proximate to the second microstrip line, a second angled slot that angles inwardly from the second coupler end slot at a second coupler angle towards the centralized intersection point, a third coupler end slot proximate to the third microstrip line, a third angled slot that angles inwardly from the third coupler end slot at a third coupler angle towards the centralized intersection point, and a second connecting slot that couples the second angled slot to the third angled slot, and that intersects the second centralized slot. The hybrid coupler further can include a bottom metallization layer comprising a ground plane, and a substrate between the top metallization layer and the bottom metallization layer.

The first centralized slot can be substantially perpendicular to the second centralized slot, and the ground plane can include a third centralized slot substantially aligned with the first centralized slot, and a fourth centralized slot substantially aligned with the second centralized slot.

The first centralized slot can include a first slot width and a first slot length, the second centralized slot can include a second slot width and a second slot length, and at least one of the first slot width, the first slot length, the second slot width or the second slot length can be usable to determine radio frequency characteristics of the hybrid coupler, the radio frequency characteristics comprising a first characteristic representative of electric field coupling strength and a second characteristic representative of magnetic field coupling strength.

The first bracket-shaped slot can be substantially symmetrical to and opposite the second bracket-shaped slot, the first connecting slot and the second connecting slot can be separated by a coupler gap distance, and the coupler gap distance can be usable to determine bandwidth characteristics of the hybrid coupler.

The first bracket-shaped slot can be substantially symmetrical to and opposite the second bracket-shaped slot, the first connecting slot and the second connecting slot can be separated by a coupler gap distance, the first coupler end slot and the second coupler end slot can be separated by a coupler end slot distance, and at least one of: the coupler gap distance, the coupler end slot distance, or the first coupler angle can be usable to determine bandwidth characteristics of the hybrid coupler.

The first coupler end slot, the second coupler end slot, the third coupler end slot, and the fourth coupler end slot can include respective length and width dimensions that can be substantially same or similar to one another, and the respective length and width dimensions can be usable to determine phase characteristics of the hybrid coupler.

The metallic upper plane can be substantially square, and wherein the intersection point of the first slot and the second slot can be substantially centered relative to the metallic upper plane.

At least one of: the first slot width, the first slot length, the second slot width, or the second slot length, can be defined at least in part based on a material of the substrate.

A center frequency of the hybrid coupler can be determined by a size of the hybrid coupler.

Respective length and width dimensions of the first port, the second port, the third port, and the fourth port can be usable to determine a characteristic impedance of the hybrid coupler.

The defined bandwidth can be greater than around three gigahertz at a center frequency greater than around fifteen gigahertz.

One or more example embodiments can be embodied in a device, such as described and represented herein. The device can include a hybrid coupler, which can include a single top metallization layer, a substrate beneath the single top metallization layer, and a single ground plane metallization layer beneath the substrate. The single top metallization layer can include an upper metallic plane portion, a first pair of opposite ports coupled to the upper metallic plane portion at first opposite sides of the upper metallic plane portion, and a second pair of opposite ports coupled to the upper metallic plane portion at second opposite sides of the upper metallic plane portion. An opening in the upper metallic plane portion can include a first centralized slot and a second centralized slot; the first centralized slot and the second centralized slot can form a cross-shaped pattern that intersects at a centralized intersection point. The single top metallization layer further can include a first coupler end slot proximate to the first microstrip line, a first slanted slot that angles inwardly from the first coupler end slot at a first coupler angle towards the centralized intersection point, a fourth coupler end slot proximate to the fourth microstrip line, and a fourth slanted slot that angles inwardly from the fourth coupler end slot at a fourth coupler angle towards the centralized intersection point. The single top metallization layer further can include a first connecting slot that couples the first slanted slot to the fourth slanted slot, and that intersects the second centralized slot, a second coupler end slot proximate to the second microstrip line, a second slanted slot that angles inwardly from the second coupler end slot at a second coupler angle towards the centralized intersection point, a third coupler end slot proximate to the third microstrip line, a third slanted slot that angles inwardly from the third coupler end slot at a third coupler angle towards the centralized intersection point, and a second connecting slot that couples the second slanted slot to the third slanted slot, and that intersects the second centralized slot.

The hybrid coupler can be incorporated into a beamforming network.

The opening in the upper metallic plane portion can be a first opening; the cross-shaped pattern can include a first cross-shaped pattern that intersects at a first centralized intersection point, and further can include a second opening in the ground plane metallization layer that can include a third centralized slot and a fourth centralized slot, in which the third centralized slot and the fourth centralized slot form a second cross-shaped pattern that intersects at a second centralized intersection point.

The upper metallic plane portion can be substantially square, the centralized intersection point can be substantially centered relative to the upper metallic plane portion, and the second centralized slot can be substantially perpendicular to the first centralized slot.

The first slot can include a first slot width and a first slot length, the second slot can include a second slot width and a second slot length, the first connecting slot and the second connecting slot can be separated by a coupler gap distance, the first coupler end slot and the second coupler end slot can be separated by a coupler end slot distance, and radio frequency characteristics of the hybrid coupler can be determined based on at least one of: the first slot width, the first slot length, the second slot width, the second slot length, the coupler gap distance, the coupler end slot distance, or the first coupler angle.

A center frequency of the hybrid coupler can be determined based on a size of the hybrid coupler.

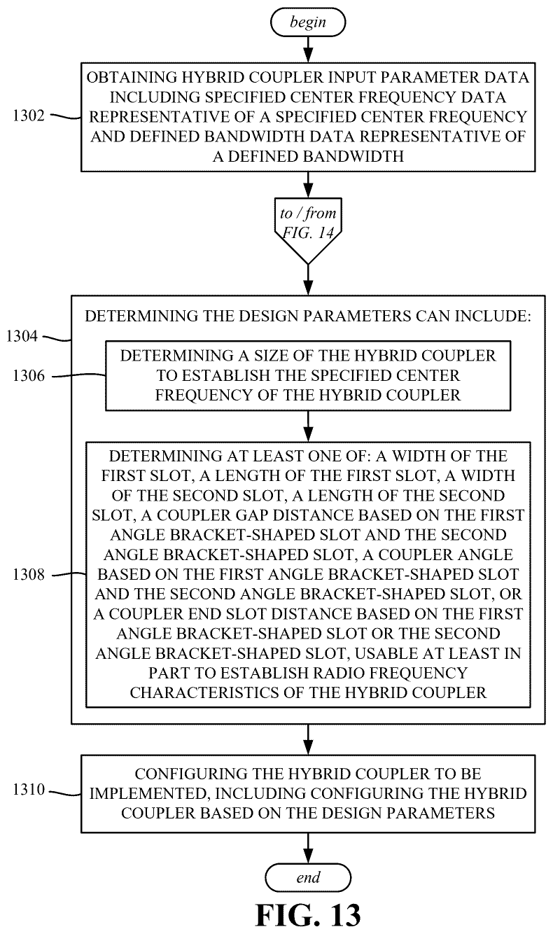

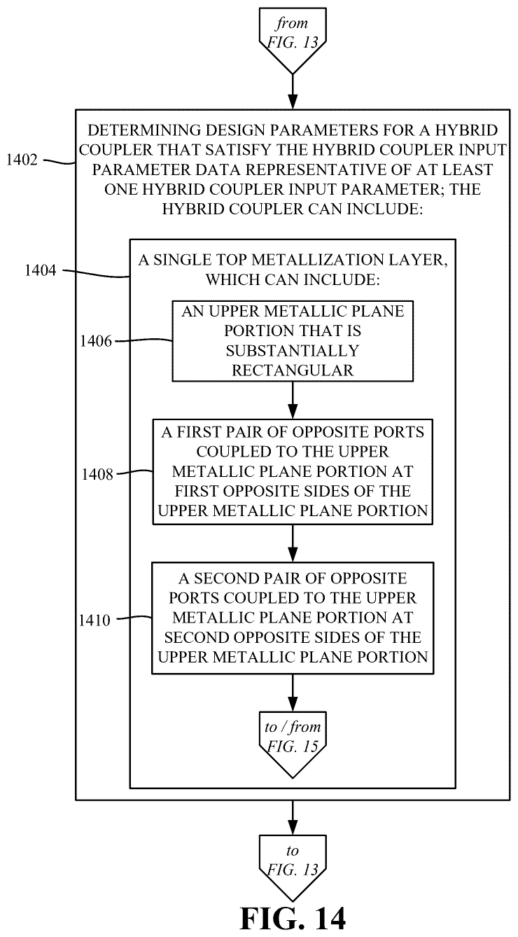

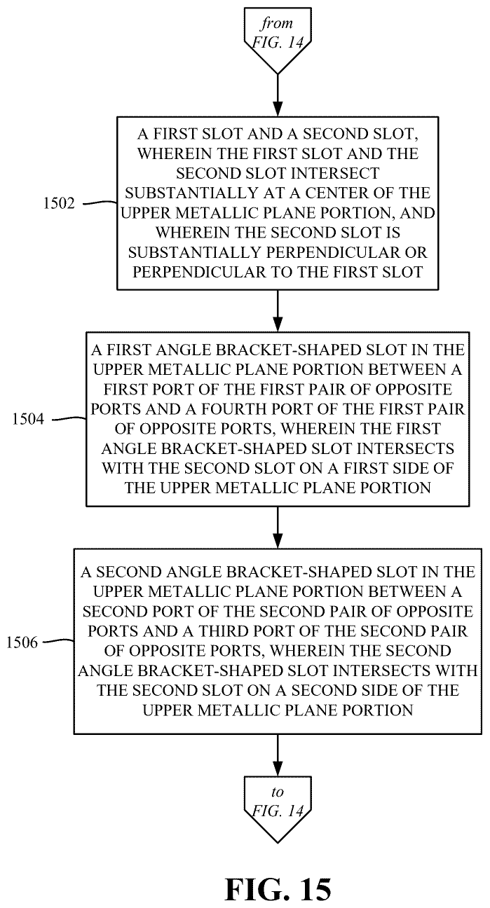

FIGS. 13-15 summarize various example operations, e.g., corresponding to a method, a computer-implemented system, and/or a machine-readable medium, including executable instructions that, when executed by a processor, that, when executed by at least one processor, facilitate performance of operations. Example operation 1302 represents obtaining hybrid coupler input parameter data including specified center frequency data representative of a specified center frequency and defined bandwidth data representative of a defined bandwidth. The operations continue at example operation 1402 of FIG. 14, which represents determining design parameters for a hybrid coupler that satisfy hybrid coupler input parameter data representative of at least one hybrid coupler input parameter. The hybrid coupler can include a single top metallization layer (block 1404), which can include an upper metallic plane portion that is substantially rectangular (block 1406). The single top metallization layer (block 1404) can further include example blocks 1408 and 1410 of FIG. 14, and example blocks 1502, 1504 and 1506 of FIG. 15. Example block 1408 represents a first pair of opposite ports coupled to the upper metallic plane portion at first opposite sides of the upper metallic plane portion. Example block 1410 represents a second pair of opposite ports coupled to the upper metallic plane portion at second opposite sides of the upper metallic plane portion. Example block 1502 of FIG. 15 represents a first slot and a second slot, wherein the first slot and the second slot intersect substantially at a center of the upper metallic plane portion, and wherein the second slot is substantially perpendicular or perpendicular to the first slot. Example block 1504 represents a first angle bracket-shaped slot in the upper metallic plane portion between a first port of the first pair of opposite ports and a fourth port of the first pair of opposite ports, wherein the first angle bracket-shaped slot intersects with the second slot on a first side of the upper metallic plane portion. Example block 1506 represents a second angle bracket-shaped slot in the upper metallic plane portion between a second port of the second pair of opposite ports and a third port of the second pair of opposite ports, wherein the second angle bracket-shaped slot intersects with the second slot on a second side of the upper metallic plane portion. The operations return to example operation 1304 of FIG. 13, where determining the design parameters can include example operations 1306 and 1308. Example operation 1306 represents determining a size of the hybrid coupler to establish the specified center frequency of the hybrid coupler. Example operation 1308 represents determining at least one of: a width of the first slot, a length of the first slot, a width of the second slot, a length of the second slot, a coupler gap distance based on the first angle bracket-shaped slot and the second angle bracket-shaped slot, a coupler angle based on the first angle bracket-shaped slot and the second angle bracket-shaped slot, or a coupler end slot distance based on the first angle bracket-shaped slot or the second angle bracket-shaped slot, usable at least in part to establish radio frequency characteristics of the hybrid coupler. Example operation 1310 represents configuring the hybrid coupler to be implemented, including configuring the hybrid coupler based on the design parameters.

Configuring the hybrid coupler to be implemented can include configuring a ground plane with a third slot parallel to and beneath the first slot, and a fourth slot parallel to and beneath the second slot.

Obtaining the hybrid coupler input parameter data can include obtaining a characteristic impedance, and wherein the determining of the design parameters further comprises determining length and width dimensions of the first pair of opposite ports, and length and width dimensions of the second pair of opposite ports, usable at least in part to establish the characteristic impedance of the hybrid coupler.

As can be seen, the technology described herein is directed to a hybrid coupler, including one implementation that uses a single top metallization layer, is passive, and does not require any interconnecting layer. The hybrid coupler is fully scalable, having low insertion loss at millimeter-wave frequencies, achieved by using various slots (cross-shaped and back-to-back slanted bracket slots) in the middle of the coupler for efficiently routing E- and H-fields to other available ports. The hybrid coupler is a broadband coupler with constant bandwidth, which helps designers easily scale the coupler to a desired frequency, without requiring any computation-heavy optimization. One result is an ultra-low-cost solution for mmWave circuits and systems, without any stringent dimensional variabilities.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A hybrid coupler, comprising:
a top metallization layer, comprising:
a metallic upper plane,
a first port coupled to the metallic upper plane via a first microstrip line, a second port coupled to the metallic upper plane via a second microstrip line, a third port coupled to the metallic upper plane via a third microstrip line, and a fourth port coupled to the metallic upper plane via a fourth microstrip line, wherein the first port is opposite the third port, the first port is adjacent to the second port, and the first port is the adjacent to the fourth port,
a first centralized slot in the metallic upper plane,
a second centralized slot in the metallic upper plane, wherein the first centralized slot crosses the second centralized slot at a centralized intersection point;
a first bracket-shaped slot in the metallic upper plane, the first bracket-shaped slot comprising:
a first coupler end slot proximate to the first microstrip line,
a first angled slot that angles inwardly from the first coupler end slot at a first coupler angle towards the centralized intersection point,
a fourth coupler end slot proximate to the fourth microstrip line,
a fourth angled slot that angles inwardly from the fourth coupler end slot at a fourth coupler angle towards the centralized intersection point, and
a first connecting slot that couples the first angled slot to the fourth angled slot, and that intersects the second centralized slot;
a second bracket-shaped slot in the metallic upper plane, the second bracket-shaped slot comprising:
a second coupler end slot proximate to the second microstrip line,
a second angled slot that angles inwardly from the second coupler end slot at a second coupler angle towards the centralized intersection point,
a third coupler end slot proximate to the third microstrip line,
a third angled slot that angles inwardly from the third coupler end slot at a third coupler angle towards the centralized intersection point, and
a second connecting slot that couples the second angled slot to the third angled slot, and that intersects the second centralized slot;
a bottom metallization layer comprising a ground plane; and
a substrate between the top metallization layer and the bottom metallization layer.

2. The hybrid coupler of claim 1, wherein the first centralized slot is substantially perpendicular to the second centralized slot, and wherein the ground plane comprises a third centralized slot substantially aligned with the first centralized slot, and a fourth centralized slot substantially aligned with the second centralized slot.

3. The hybrid coupler of claim 1, wherein the first centralized slot comprises a first slot width and a first slot length, wherein the second centralized slot comprises a second slot width and a second slot length, and wherein at least one of the first slot width, the first slot length, the second slot width or the second slot length is usable to determine radio frequency characteristics of the hybrid coupler, the radio frequency characteristics comprising a first characteristic representative of electric field coupling strength and a second characteristic representative of magnetic field coupling strength.

4. The hybrid coupler of claim 1, wherein the first bracket-shaped slot is substantially symmetrical to and opposite the second bracket-shaped slot, wherein the first connecting slot and the second connecting slot are separated by a coupler gap distance, and wherein the coupler gap distance is usable to determine bandwidth characteristics of the hybrid coupler.

5. The hybrid coupler of claim 1, wherein the first bracket-shaped slot is substantially symmetrical to and opposite the second bracket-shaped slot, wherein the first connecting slot and the second connecting slot are separated by a coupler gap distance, wherein the first coupler end slot and the second coupler end slot are separated by a coupler end slot distance, and wherein at least one of: the coupler gap distance, the coupler end slot distance, or the first coupler angle is usable to determine bandwidth characteristics of the hybrid coupler.

6. The hybrid coupler of claim 1, wherein the first coupler end slot, the second coupler end slot, the third coupler end slot, and the fourth coupler end slot comprise respective length and width dimensions that are substantially same or similar to one another, and wherein the respective length and width dimensions are usable to determine phase characteristics of the hybrid coupler.

7. The hybrid coupler of claim 1, wherein the metallic upper plane is substantially square, and wherein the intersection point of the first slot and the second slot is substantially centered relative to the metallic upper plane.

8. The hybrid coupler of claim 1, wherein at least one of: the first slot width, the first slot length, the second slot width, or the second slot length, is defined at least in part based on a material of the substrate.

9. The hybrid coupler of claim 1, wherein a center frequency of the hybrid coupler is determined by a size of the hybrid coupler.

10. The hybrid coupler of claim 1, wherein respective length and width dimensions of the first port, the second port, the third port, and the fourth port are useable to determine a characteristic impedance of the hybrid coupler.

11. The hybrid coupler of claim 1, wherein the defined bandwidth is greater than around three gigahertz at a center frequency greater than around fifteen gigahertz.

12. A device, comprising:
a hybrid coupler, comprising:
a single top metallization layer;
a substrate beneath the single top metallization layer; and
a single ground plane metallization layer beneath the substrate;
wherein the single top metallization layer comprises:
an upper metallic plane portion;
a first pair of opposite ports coupled to the upper metallic plane portion at first opposite sides of the upper metallic plane portion,
a second pair of opposite ports coupled to the upper metallic plane portion at second opposite sides of the upper metallic plane portion,
an opening in the upper metallic plane portion comprising a first centralized slot and a second centralized slot, wherein the first centralized slot and the second centralized slot form a cross-shaped pattern that intersects at a centralized intersection point,
a first coupler end slot proximate to the first microstrip line,
a first slanted slot that angles inwardly from the first coupler end slot at a first coupler angle towards the centralized intersection point,
a fourth coupler end slot proximate to the fourth microstrip line,
a fourth slanted slot that angles inwardly from the fourth coupler end slot at a fourth coupler angle towards the centralized intersection point, and
a first connecting slot that couples the first slanted slot to the fourth slanted slot, and that intersects the second centralized slot,
a second coupler end slot proximate to the second microstrip line,
a second slanted slot that angles inwardly from the second coupler end slot at a second coupler angle towards the centralized intersection point,
a third coupler end slot proximate to the third microstrip line,
a third slanted slot that angles inwardly from the third coupler end slot at a third coupler angle towards the centralized intersection point, and
a second connecting slot that couples the second slanted slot to the third slanted slot, and that intersects the second centralized slot.

13. The device of claim 12, wherein the hybrid coupler is incorporated into a beamforming network.

14. The device of claim 12, wherein the opening in the upper metallic plane portion is a first opening, wherein the cross-shaped pattern comprises a first cross-shaped pattern that intersects at a first centralized intersection point, and further comprising:
a second opening in the ground plane metallization layer comprising a third centralized slot and a fourth centralized slot, wherein the third centralized slot and the fourth centralized slot form a second cross-shaped pattern that intersects at a second centralized intersection point.

15. The device of claim 12, wherein the upper metallic plane portion is substantially square, wherein the centralized intersection point is substantially centered relative to the upper metallic plane portion, and wherein the second centralized slot is substantially perpendicular to the first centralized slot.

16. The device of claim 12, wherein the first slot comprises a first slot width and a first slot length, wherein the second slot comprises a second slot width and a second slot length, wherein the first connecting slot and the second connecting slot are separated by a coupler gap distance, wherein the first coupler end slot and the second coupler end slot are separated by a coupler end slot distance, and wherein radio frequency characteristics of the hybrid coupler are determined based on at least one of: the first slot width, the first slot length, the second slot width, the second slot length, the coupler gap distance, the coupler end slot distance, or the first coupler angle.

17. The device of claim 12, wherein a center frequency of the hybrid coupler is determined based on a size of the hybrid coupler.

18. A non-transitory machine-readable medium, comprising executable instructions that, when executed by at least one processor, facilitate performance of operations, the operations comprising:
obtaining hybrid coupler input parameter data comprising specified center frequency data representative of a specified center frequency and defined bandwidth data representative of a defined bandwidth;
determining design parameters for a hybrid coupler that satisfy the hybrid coupler input parameter data representative of at least one hybrid coupler input parameter, the hybrid coupler comprising:
a single top metallization layer, comprising:
an upper metallic plane portion that is substantially rectangular;
a first pair of opposite ports coupled to the upper metallic plane portion at first opposite sides of the upper metallic plane portion,
a second pair of opposite ports coupled to the upper metallic plane portion at second opposite sides of the upper metallic plane portion,
a first slot and a second slot, wherein the first slot and the second slot intersect substantially at a center of the upper metallic plane portion, and wherein the second slot is substantially perpendicular or perpendicular to the first slot;
a first angle bracket-shaped slot in the upper metallic plane portion between a first port of the first pair of opposite ports and a fourth port of the first pair of opposite ports, wherein the first angle bracket-shaped slot intersects with the second slot on a first side of the upper metallic plane portion;
a second angle bracket-shaped slot in the upper metallic plane portion between a second port of the second pair of opposite ports and a third port of the second pair of opposite ports, wherein the second angle bracket-shaped slot intersects with the second slot on a second side of the upper metallic plane portion,
wherein the determining of the design parameters comprises,
determining a size of the hybrid coupler to establish the specified center frequency of the hybrid coupler, and
determining at least one of: a width of the first slot, a length of the first slot, a width of the second slot, a length of the second slot, a coupler gap distance based on the first angle bracket-shaped slot and the second angle bracket-shaped slot, a coupler angle based on the first angle bracket-shaped slot and the second angle bracket-shaped slot, or a coupler end slot distance based on the first angle bracket-shaped slot or the second angle bracket-shaped slot, usable at least in part to establish radio frequency characteristics of the hybrid coupler; and
configuring the hybrid coupler to be implemented, comprising configuring the hybrid coupler based on the design parameters.

19. The non-transitory machine-readable medium of claim 18, wherein the configuring of the hybrid coupler to be implemented comprises configuring a ground plane with a third slot parallel to and beneath the first slot, and a fourth slot parallel to and beneath the second slot.

20. The non-transitory machine-readable medium of claim 18, wherein the obtaining of the hybrid coupler input parameter data comprises obtaining a characteristic impedance, and wherein the determining of the design parameters further comprises determining length and width dimensions of the first pair of opposite ports, and length and width dimensions of the second pair of opposite ports, usable at least in part to establish the characteristic impedance of the hybrid coupler.
